(19) United States
(12) Patent Application Publication
(10) Pub. No.: US 2003/0061191 A1
(43) Pub. Date: Mar. 27, 2003

(54) Replacement selection with duplicate key handling

(75) Inventor: Steven R. Pearson, Portland, OR (US)

Correspondence Address: IBM CORPORATION, IP LAW DEPT, ED02-905, 15450 SW KOLL PARKWAY, BEAVERTON, OR, 97006-6063, US

(73) Assignee: International Business Machines Corporation, Armonk, NY

(21) Appl. No.: 09/960,118

(22) Filed: Sep. 21, 2001

(51) Int. Cl. G06F 7/00

(52) U.S. Cl. 707/1

(57) ABSTRACT

The replacement selection algorithm for ordered merging is improved by remembering at each node of the selection tree when a losing data item is a duplicate of the prior winning data item at that node. The next time a key comparison between data items would be performed at such a node, it is not, and instead the duplicate prior loser is instantly promoted to be the next winner, avoiding the need for any further key comparisons for that winner. A data item's “duplicate” status in a node is indicated by a value of a status indicator having other values corresponding to “empty”, “merging” and “done”. The status indicator is an integer variable in the array data structure representing the selection tree, and has values 0 (empty), 1 (duplicate), 2 (merging), and 3 (done), so that comparisons of two integer values of status indicators can determine whether a duplicate value is ready for instant promotion to become the winning data item.

### BACKGROUND OF THE INVENTION

1. Technical Field

This invention relates to computerized merging and sorting of data, and more particularly to algorithms for ordered merging and sorting by replacement selection.

2. Description Of The Prior Art

Ordered merging by replacement selection is famously described in Knuth's “Art of Computer Programming”, volume III. Ordered merging by replacement selection merges two or more sorted input streams into a single sorted output stream. A binary selection tree is built over the input streams, as seen in FIG. 5A. Each node of the tree stores information about the “loser” of a prior sort key comparison among its children. When a winner is chosen, the next item from its input stream is chosen as the next candidate to enter the “tournament”; it enters at the bottom level of the tree in the spot vacated by the prior winner. The new candidate is compared to the prior loser at the node in the selection tree just above its stream. The winner of that comparison is then compared to the loser at the next level up the tree, while the loser is left behind at the node where it lost. In this fashion, log₂N comparisons are needed to produce each successive output (winner) from the merge, where N is the number of input streams.

Generally, the criteria used to pick a winner at each level is to compare the sort-key value of the current candidate to the sort-key value of the prior loser in a key comparison, and only swap them if the prior loser has a lower sort-key value than the current candidate. For equal or “duplicate” key values, after the key comparison the swap can be omitted since conceptually it doesn't matter which one of the duplicate data items is output. Note that existing routines used to perform key comparison are typically aware of duplicate keys, returning −1, 0, or 1 to signify the <, =, or > relationship between the compared keys.

The conventional replacement selection delivers sub-optimal performance when duplicate sort-key values are present. This is due to unnecessary key comparisons when merging, to unbalanced consumption of inputs, and to unnecessary key comparisons in final duplicate elimination.

Furthermore, a deadlock may occur in conventional replacement selection due to unbalanced consumption of data items from the input streams when all of the following conditions exist;

(1) there are a large number of duplicate keys,

(2) there are buffering or data flow limits on the amount of resources consumed to move data items from the sorted source to the merge operator,

(3) the sort/merge is parallelized among more than one sort and more than one merge, and

(4) the sorted output is partitioned among the merge operators via the sort key (or another key functionally dependent on the same).

One common method known in the art for coping with more data than can be accomodated in memory due to resource limitations is “spooling.” This generally involves removing data items from the normal execution flow by temporarily copying them to an alternate location, and then retrieving them later when they can be accomodated. The deadlock situation described above can be prevented by spooling data items between the sorted source and the merge operator. However spooling increases the processing cost, particularly if the secondary storage location is on disk, which is typical.

An alternative solution to the deadlock problem forces the operators that produce the sorted streams check to see if a consuming merge is being “starved”, and if so, to send it a dummy sort key value that may be useful in selecting the next winner in the merge but cannot itself be produced as a winner because it does not fit in the key partitioning for the target merge operator.

Where the number of input streams is an even power of 2 the deadlock can also be reliably corrected by changing the base replacement selection algorithm to swap loser for winner when the loser's sort key is greater than or equal to that of the current candidate winner, as opposed to only swapping when the loser's key is definitely greater than the candidate winner's key (i.e., using “>=” instead of “>”). While this change does tend to even out the consumption of inputs compared to the conventional replacement selection algorithm, it does not do so perfectly unless the number of inputs is a power of 2. In any subtree of the selection tree covering an odd number of inputs, this change will result in faster consumption from the “incomplete” half of the binary tree as compared to the “complete” half. This means that the deadlock can still occur if the number of duplicate keys is sufficiently large. Furthermore, this change dramatically increases the number of swap operations needed to complete the merge.

### SUMMARY OF THE INVENTION

A first aspect of this invention resides in a replacement selection method for organizing data items from two or more input streams, the method providing improved handling of duplicate data items. In this method, a data item being processed from one of the input streams is identified as being a duplicate of a previously processed data item. An indication that the data item being processed is a duplicate data item is retained, and the data items are organized responsive at least in part to that indication.

A second aspect of this invention resides in a computer-readable data structure representing a selection tree for use in a computer-implemented replacement selection method for organizing data items from two or more input streams. This data structure comprises for each node of the selection tree: an identifier of one of the input streams; a reference to a data item being processed from that one of the input streams; and an indication whether the data item being processed is a duplicate.

A third aspect of this invention resides in an article for use in a computer implemented replacement selection method for organizing data items from two or more input streams. The article comprises a computer-readable signal-bearing medium with means in the medium for identifying a data item being processed from one of the input streams as being a duplicate of a previously processed data item. The medium also has in it means for retaining an indication that the data item being processed is a duplicate data item, and means for organizing the data items responsive at least in part to that indication.

The identification and handling of duplicate data items improves the performance and reliability of ordered merge by replacement selection, and of other uses of replacement selection such as the generation of initial runs of sorted data items from unsorted or partially sorted input streams, by permitting the avoidance of unnecessary key comparisons between duplicates and the avoidance of potentially crippling deadlocks in processing under selected circumstances. Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flowchart of a computer algorithm for replacement selection according to the preferred embodiment of this invention.

FIG. 2 is a flowchart of the section of the algorithm of FIG. 1 for determining the next winning key value, and is suggested for printing on the first page of the issued patent

FIG. 3 is a flowchart of the section of the algorithm of FIG. 1 for eliminating duplicate key values.

FIG. 4 is a flowchart of the section of the algorithm of FIG. 1 for initializing data structures use by the program.

FIGS. 5A-5L are tree diagrams of a replacement selection tree showing operation of the algorithm of FIGS. 1-4.

### DESCRIPTION OF THE PREFERRED EMBODIMENT

### Overview

The invention modifies the replacement selection algorithm by remembering at each node when a loser was a duplicate of the prior winner at that level. The next time a key comparison would be performed at such a node, skip it (and all the key comparisons above it) and immediately promote the prior loser (duplicate) to be the next winner.

At each node in a loser-oriented selection tree, the data item represented there (prior loser) is the next winner for all of its subtree, with the possible exception of the value which replaces the prior overall winner. In a node marked as a duplicate, the loser's key value is the same as that for the prior winner in that subtree. Due to the nature of replacement selection, any comparison at a selection tree node implies that the prior overall winner came from the same subtree. Thus, if we are considering a comparison with a loser that is marked as a duplicate, we can be sure that that loser's sort-key value is the same as that of the prior overall winner.

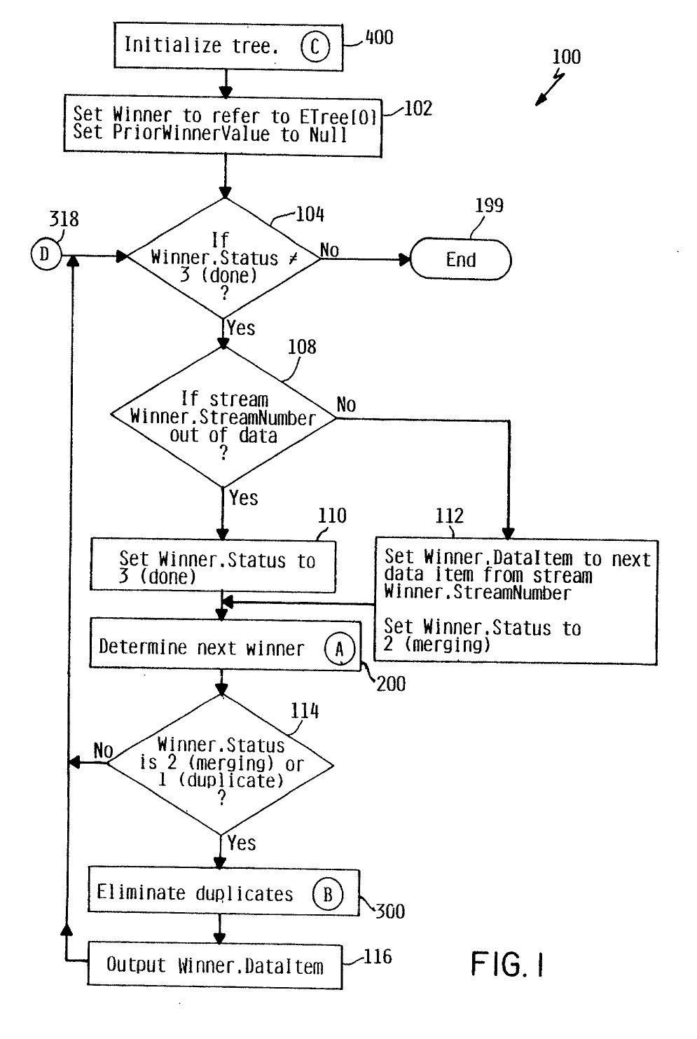

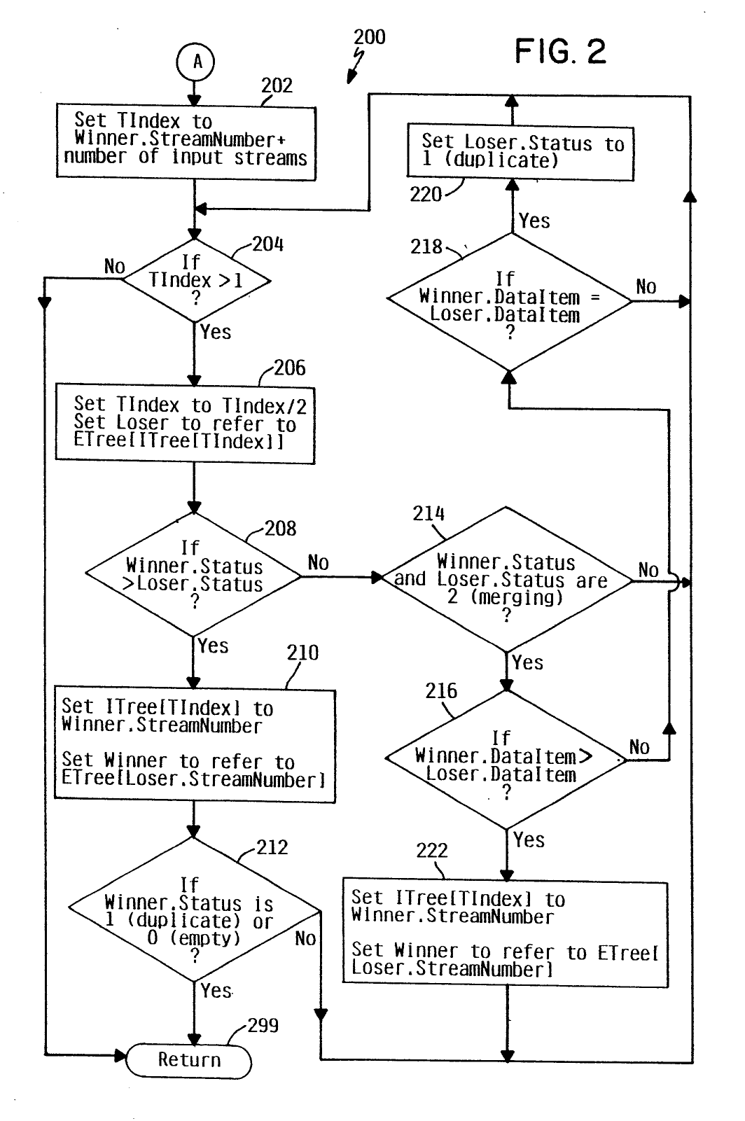

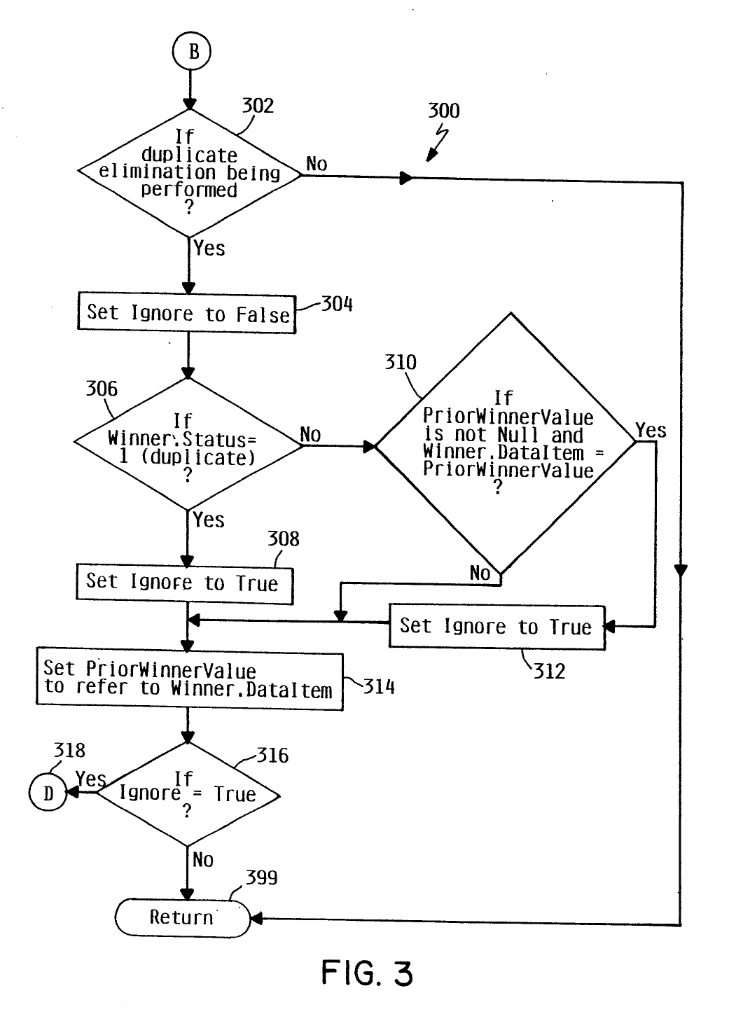

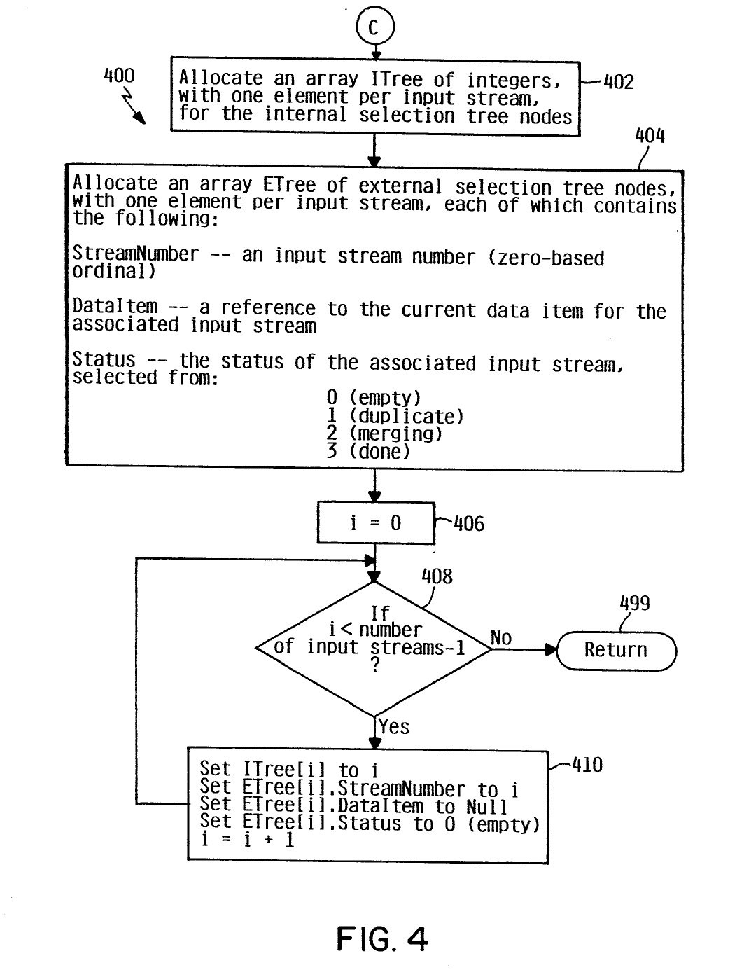

FIGS. 1-4 are flowcharts showing the operation of the improved replacement selection algorithm of the preferred embodiment of this invention. FIG. 1 shows the overall operation of the algorithm, beginning with initialization 400 and the main or outer loop 104-116 which contains sections for determining the next winner 200 and eliminating duplicates 300. FIG. 2 details the section 200 for determining the next winner, while FIG. 3 details the section 300 for eliminating duplicates if duplicate elimination is being performed and FIG. 4 details section 400 which initializes the tree as the first step of the algorithm.

### Initialization of the Tree

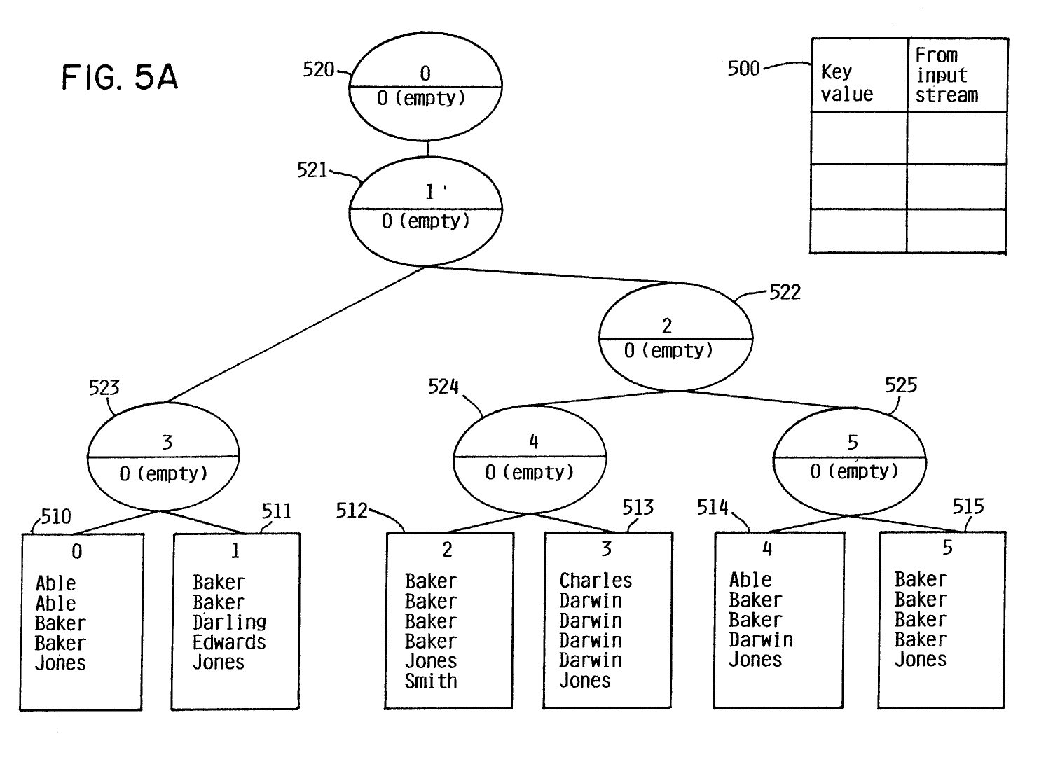

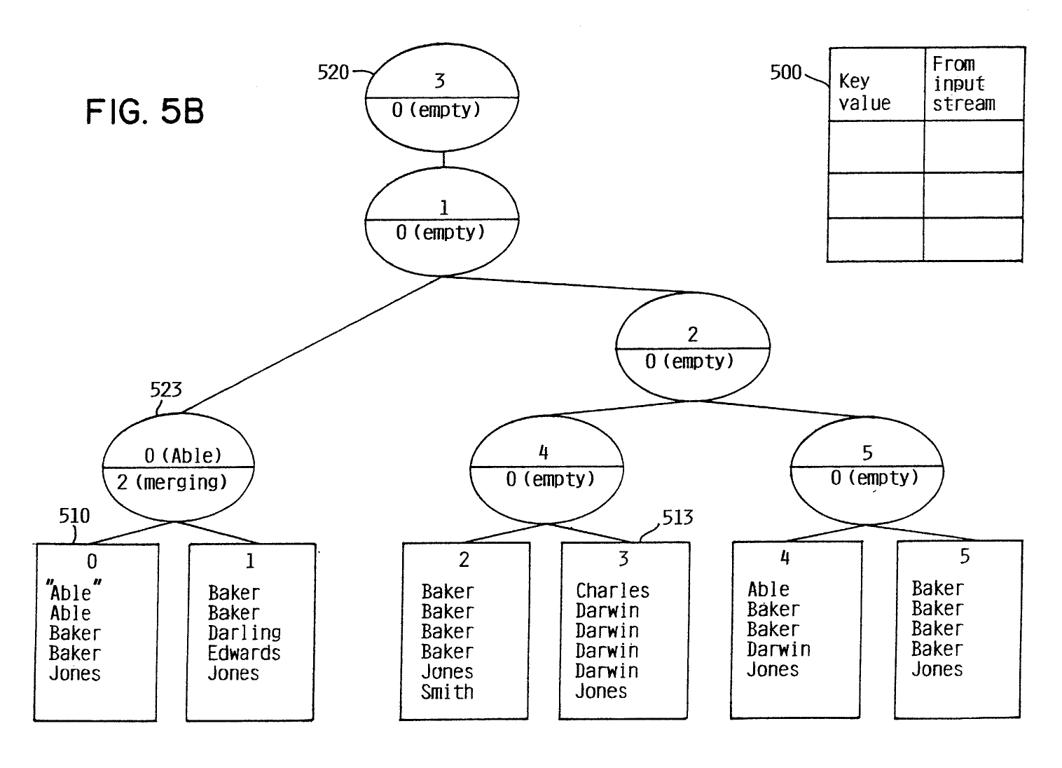

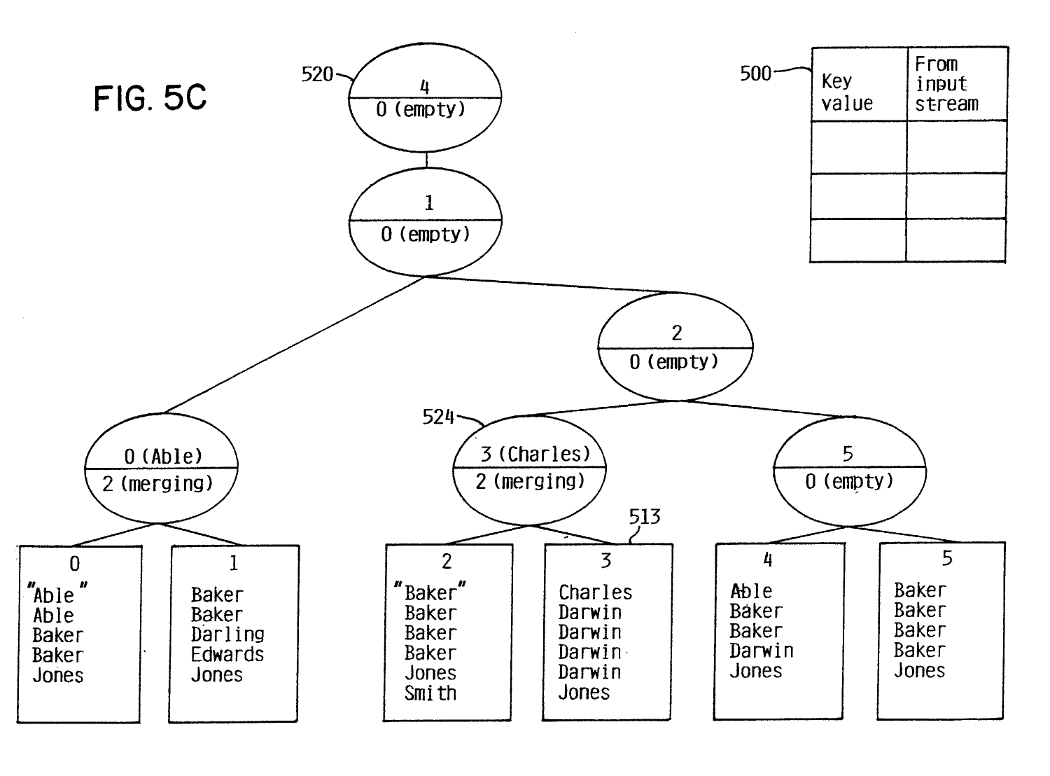

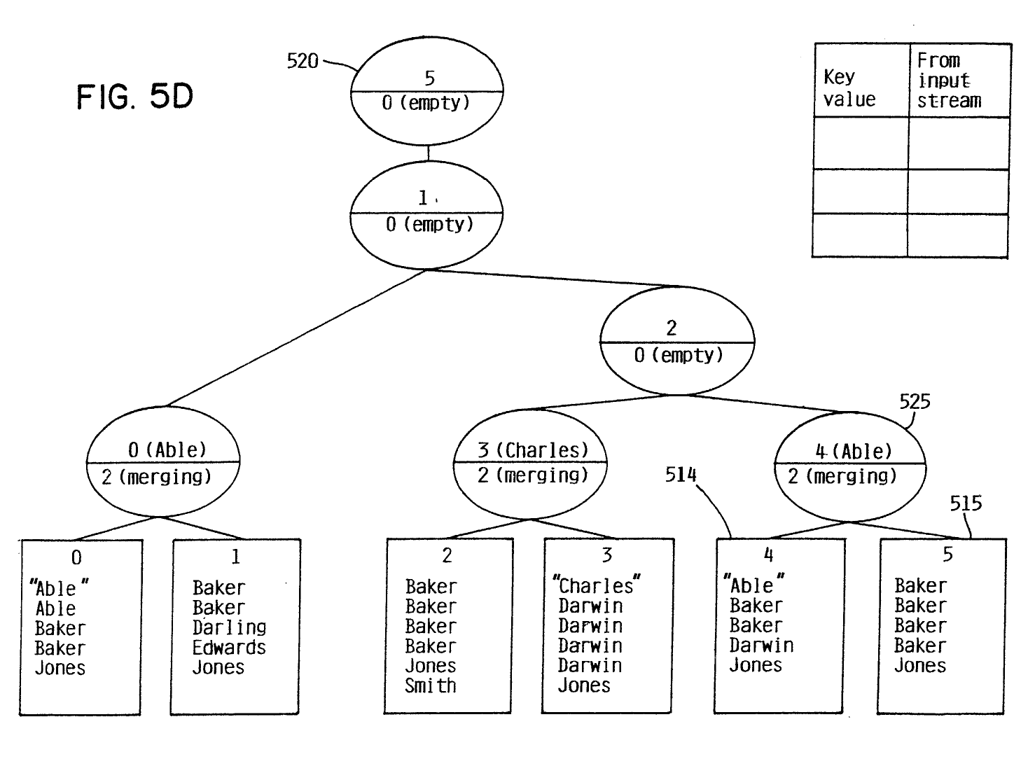

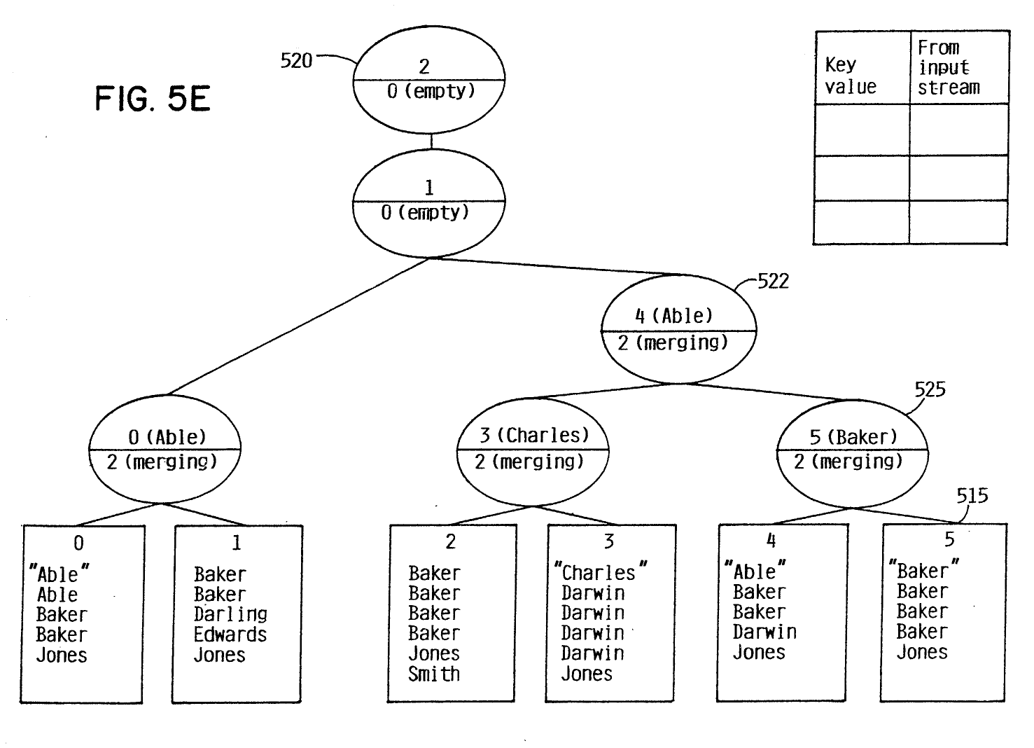

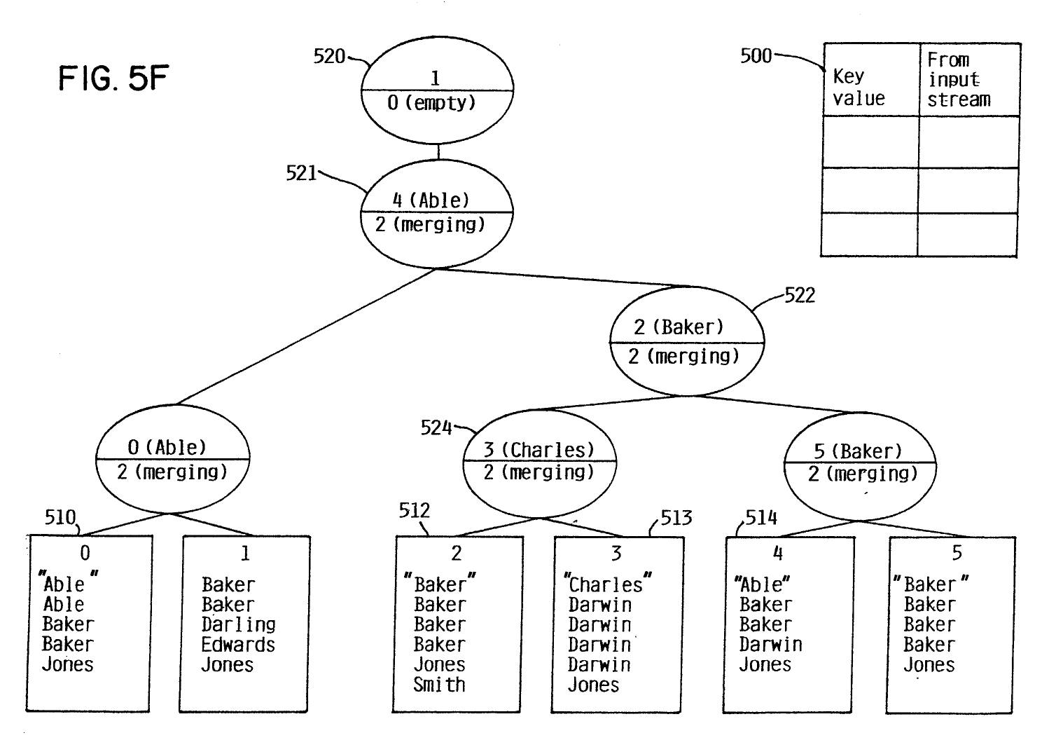

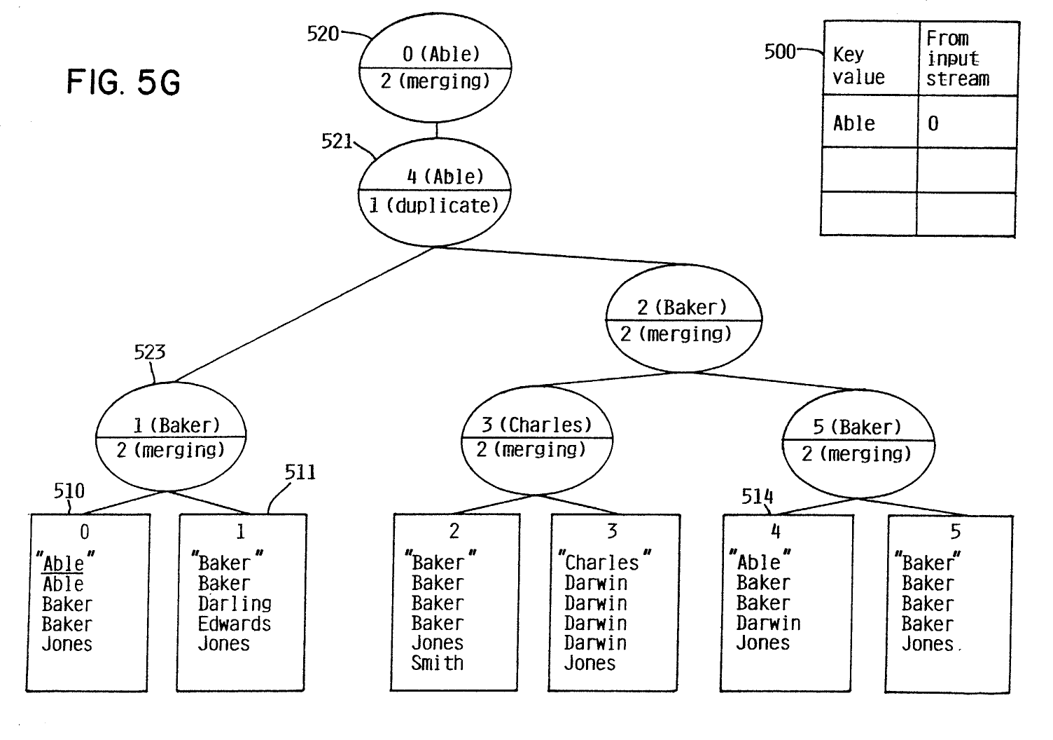

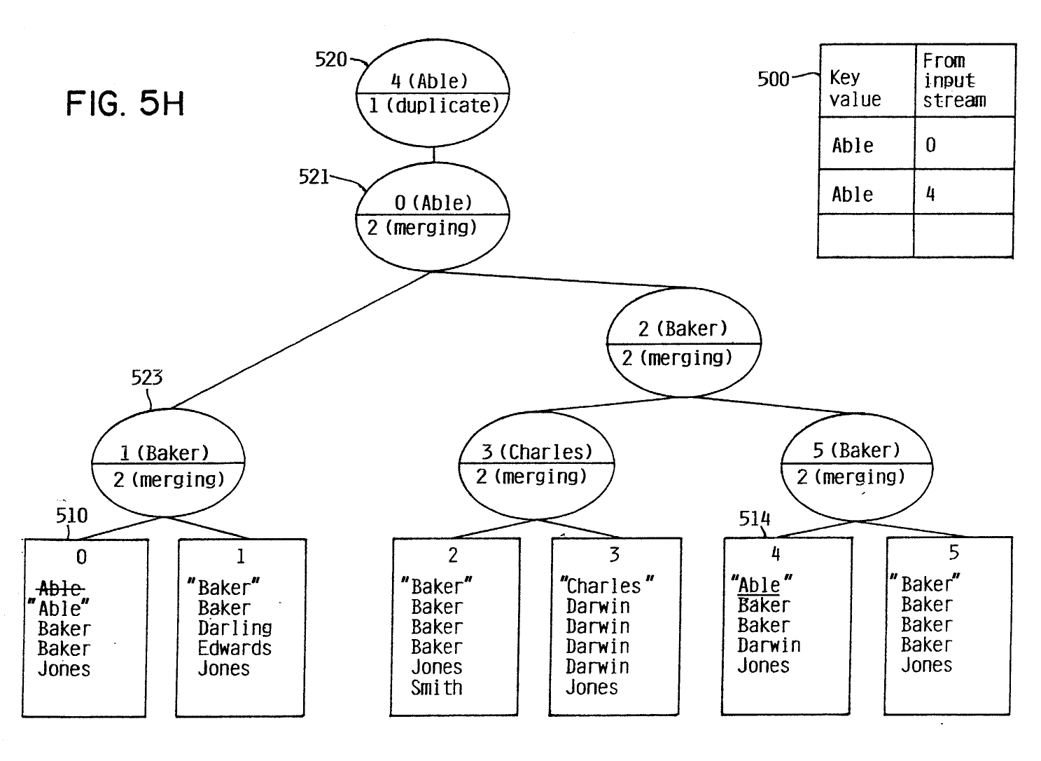

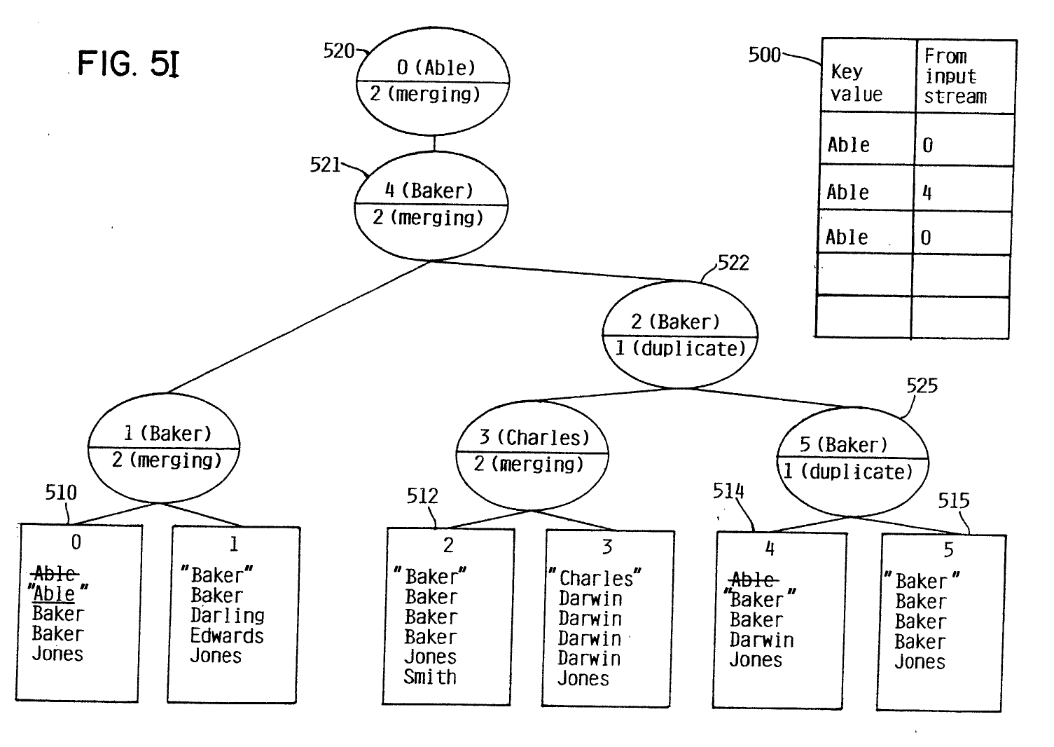

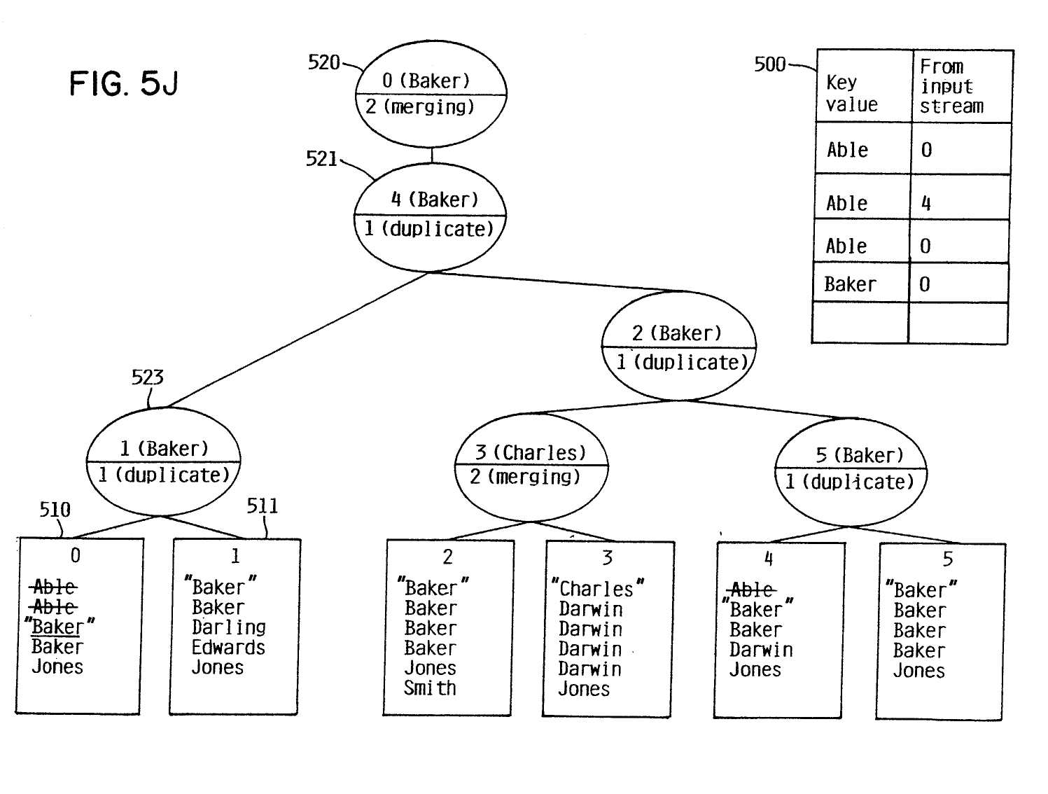

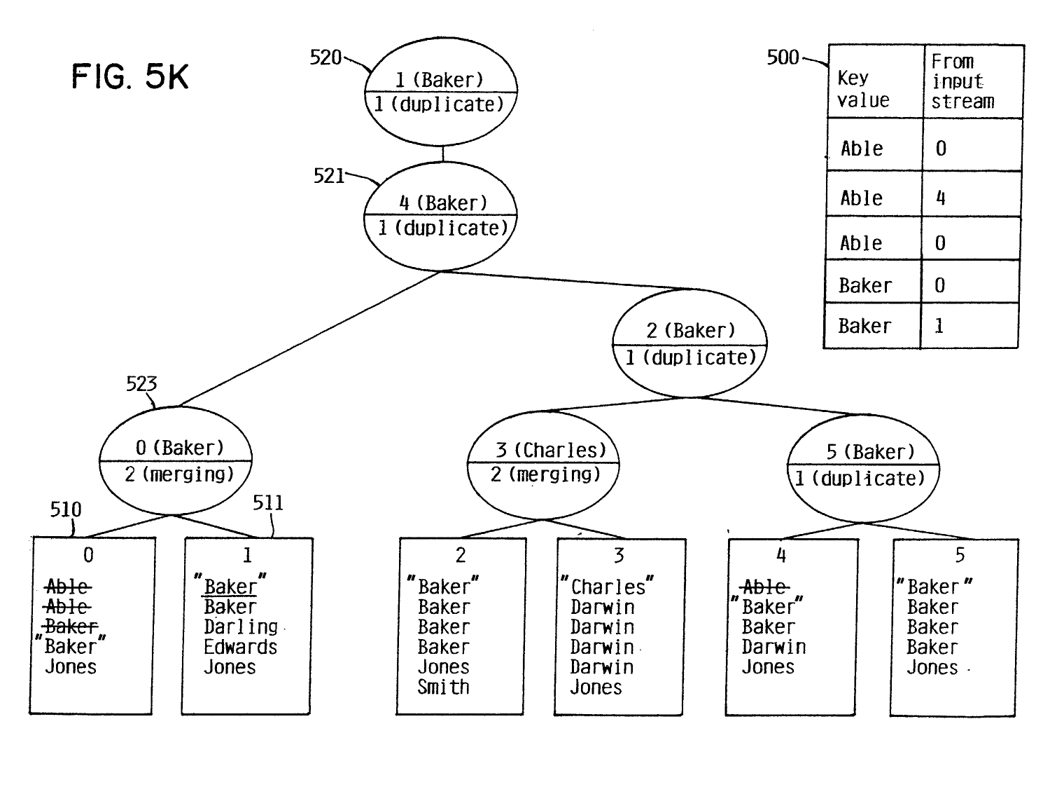

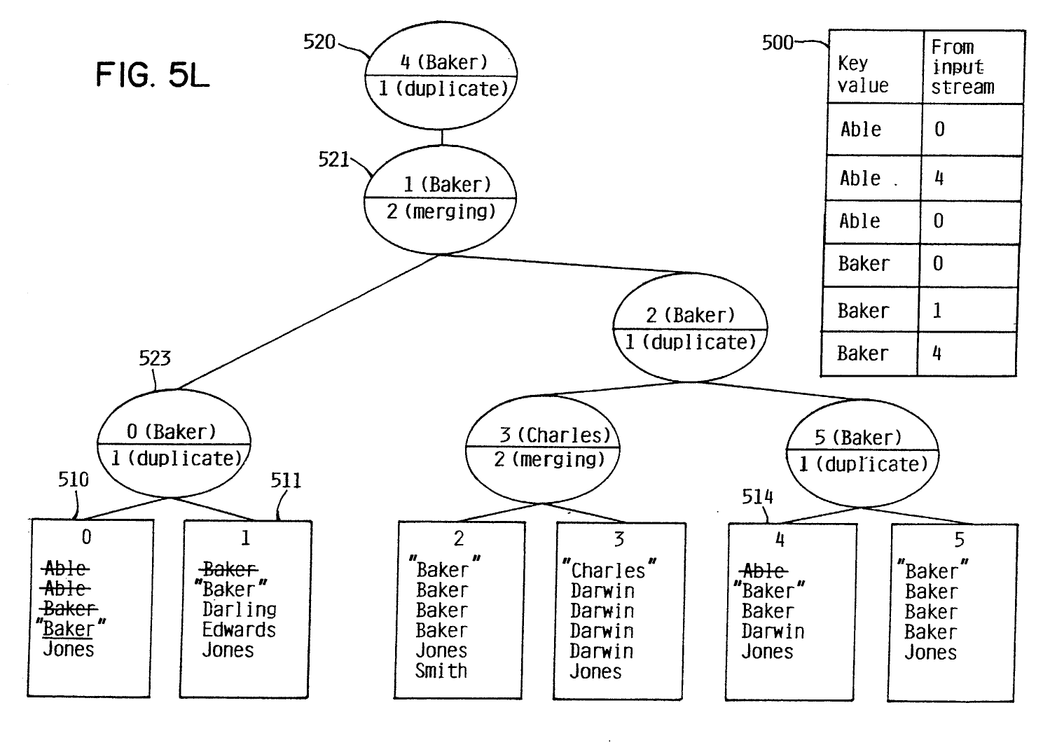

As seen in FIG. 4, initialization section 400 begins by creating and initializing the data structures for a selection tree for use by the replacement selection algorithm. Step 402 allocates an array “ITree” containing a single integer value for each of the input streams 510-515 shown in FIG. 5A. Next, step 404 allocates a second array “ETree” containing the data structures representing the external selection tree nodes. ETree contains one element for each of the input streams 510-515, each input stream's element containing three items: StreamNumber identifying one of the input streams; DataItem referencing the current data item for the associated input stream; and Status identifying the status of the associated input stream. The improvement of this invention is made possible by including a status identifier indicating that a given input stream contains a duplicate key value. The values of the status indicators are thus one of:

0 (empty)

1 (duplicate)

2 (merging)

3 (done)

By adding a fourth status value of 1 (duplicate) the algorithm can process duplicate key values with fewer key comparisons than required by the conventional replacement selection algorithm.

Steps 406-410 are a do loop which initializes the elements of ITree and ETree in a substantially conventional manner which will not be described further. The do loop exits 499 and returns to step 102 of the main algorithm as shown in FIG. 1.

### Key Value Comparison

Referring again to FIG. 1, step 102 sets initial values to initialize the main loop of steps 104-116, setting Winner to refer to the first (0) node of the external selection tree ETree, and setting the value of the Prior Winner Value to “null”. At step 104, if the previous winner was taken from an input stream which has been exhausted of values to be processed, the status indicator of that winner would have been set to 3 (done) and step 104 would cause the main loop to exit ending the algorithm at step 199. Otherwise step 108 tests whether the stream identified by the last winner's input stream identifier contains more values or is out of data. If that stream is out of data, the status of the winner is set to 3 (done) at step 110. Otherwise, step 112 sets Winner.DataItem to the next DataItem from the stream which produced the previous winner, and Winner.Status is set to 2 (merging).

Whether step 110 or 112 is executed, the next step determines the next winner according to the section 200 shown in FIG. 2. After the winner is determined by step 200, step 114 branches back to the top step 104 of the main loop if Winner.Status is either 0 (empty) or 3 (done), and nothing is output to the output stream 500. If the winning entry's status Winner.Status is either 2 (merging) or 1 (duplicate), duplicate key values are eliminated by step 300 shown in FIG. 3 (if duplicate elimination is being performed in the merge). If the winning key value is not eliminated as a duplicate by step 300, step 116 outputs the key value to the output stream 500, and control is returned to the top of the main loop at step 104. The main loop is repeated until all input streams have been exhausted, at which point Winner.Status is equal to 3 (done) and the program ends at step 199.

FIG. 2 shows how the next winner of the selection tree is determined using an inner loop which traverses the selection tree to process the next data item Winner.DataItem from the stream identified by the previous winning stream identifier Winner.StreamNumber. First, step 202 sets the loop control variable TIndex to equal Winner.StreamNumber plus the number of input streams, which is also equal to the number of nodes in the tree. The inner loop is entered at step 204, where TIndex is tested—if TIndex is greater than one the loop is entered; otherwise control is returned to the main loop by step 299. At step 206 TIndex is divided in half using integer division with truncation, and the variable Loser is set to refer to the entry in the external selection tree ETree corresponding to ITree[TIndex], which in the first pass through this inner loop identifies the selection tree node immediately above the input stream which produced the previous winner.

The status indicators of Winner and Loser are compared at step 208, and if Winner.Status is greater than Loser.Status than Winner and Loser are swapped based on the values of their status indicators alone and without doing a key comparison. Step 210 performs this swap setting ITree[TIndex] equal to Winner.StreamNumber, and setting Winner to refer to Etree[Loser.StreamNumber]. After the swap of step 210, step 212 tests whether Winner.Status is equal to 1 (duplicate) or 0 (empty), and if either is true control is returned to the main loop by step 299, indicating that the current winner has been instantly promoted to the winning node of the selection tree.

However, if the status indicator comparison of step 208 shows that Winner.Status is less than or equal to Loser.Status, control branches to step 214 which tests whether Winner.Status and Loser.Status are both equal to 2 (merging). If they are not both merging, from step 214, control returns to the top of the inner loop. Otherwise, control proceeds to step 216 which performs a key comparison between a Winner.DataItem and Loser.DataItem. If Winner.DataItem is greater than Loser.DataItem, step 222 performs a swap in response to that key comparison, setting ITree[TIndex] to Winner.StreamNumber, and setting Winner to refer to the entry in the external selection tree ETree corresponding to Loser.StreamNumber, before returning control to the top of the interloop at step 204.

If the key comparison of step 216 does not result in a swap, step 218 tests for duplicate key values, which if found are identified by setting Loser.Status equal to 1 (duplicate) at step 200 before control is returned to the top of the interloop at step 204.

This interloop is repeated until the test at step 204 indicates that TIndex is less than or equal to 1, at which point step 299 returns control to the main loop.

### Post-merge Duplicate Elimination

Step 300 tests for and performs post-merge duplicate elimination as shown in FIG. 3. First, step 302 determines whether duplicate elimination is being performed, and if not immediately branches to step 399 to return control to the main loop. If duplicate elimination is being performed, step 304 sets variable Ignore to “false”, and step 306 tests whether Winner.Status is equal to 1 (duplicate). If a duplicate is identified by Winner.Status being equal to 1 (duplicate), then step 308 sets variable Ignore to “true”. Otherwise if Winner.Status is not equal to 1 (duplicate), step 310 tests whether variable PriorWinnerValue is not null and Winner.DataItem is equal to PriorWinnerValue. If so, step 312 sets variable Ignore to “true”. In all cases, at step 314 variable PriorWinnerValue is set to refer to Winner.Data.Item. Then step 316 checks whether variable Ignore is equal to “true”, and if so branches control to the top of the main loop 318, thereby preventing execution of step 116 of the main loop which would output Winner.DataItem. However, if variable Ignore is “false”, control is returned to the main loop where Winner.Status can be tested by step 114 and Winner.DataItem can be output to the output stream 500 by step 116.

### Example of Operation

The operation of the preferred replacement selection algorithm of the preferred embodiment of this invention is illustrated in the tree diagrams of FIGS. 5A-5L. FIG. 5A shows the initial states of the output stream 500, input streams 510-515, and tree nodes 520-525. Initially the output stream 500 is empty, input stream 510-515 have not been accessed, and nodes 520-525 are empty. In FIG. 5A each node is shown having in its top portion a value indicating the input stream 510-515 from which that current key value was taken, and in its bottom portion a status indicator showing the status of the input stream represented in the top portion of the node. Since the nodes 520-525 are initially empty, each is assigned an arbitrary number between 0 and 5, each corresponding to a respective one of the input streams 510-515. The status indicator of each node 520-525 is set to a value of 0, corresponding to the “empty” status.

FIG. 5B shows the first step in loading the nodes. Because node 520, representing the last winning value, identifies input stream 510, the first key value is loaded into node 523 from input stream 510. In the example of FIGS. 5A-5L, the first key value in input stream 510 is “Able”. Node 523 is assigned the status 2, indicating that it is “merging” by step 112 of the algorithm. Since the previous status indicator of node 523 (shown in FIG. 5A) was 0 (empty), the input stream 513 and corresponding status value are instantly promoted to the winning node 520. However, since node 520 has status of 0 (empty), the key value from input stream 513 is not copied to output stream 500.

FIG. 5C shows the next step in loading the tree. Because winning node 520 identified input stream 513 in the previous step (FIG. 5B), the next key value is taken from that input stream 513 and loaded into node 524 with status 2 (merging). As in the previous step, because the status of the previous value in node 524 was 0 (empty), those previous contents of node 524 are instantly promoted to the winning node 520. As before, because the new contents of node 520 have status 0 (empty), no key value is added to output stream 500. Similarly, in the next step shown in FIG. 5D, the next key value “Able” is taken from input stream 514, the previous winning stream identified in winning node 520 and loaded in node 525 with status 2 (merging). The previous contents of node 525, identifying input stream 515 with status 0 (empty), are instantly promoted to the winning node 520.

FIG. 5E shows the first key comparison between two nodes during the initialization of the tree. Because winning node 520 in the previous step (FIG. 5D) identified input stream 515, in FIG. 5E the next key value is taken from that input stream 515 and loaded. However, because the key value “Able” from input stream 514 was already loaded into that node 525 in the previous step of FIG. 5D, the status comparison of step 208 branches to step 214, which determines that the status of both the previous key value in node 525 and the new key value from input stream 515 are both 2 (merging). Forming the key comparison of step 216, the Winner.DataItem “Baker” is greater than the key value “Able” of Loser.DataItem, such that step 218 replaces the contents of node 525 with the identifier of input stream 515 with status 2 (merging), and promotes the previous contents of node 525, input stream 514 with key value “Able” and status 2 (merging), to node 522. Because the previous contents of node 522 identified input stream 512 with status 0 (empty), those contents are instantly promoted to winning node 520, but not written to output stream 500 due to having status 0 (empty).

In FIG. 5F, the next key value is “Baker” is taken from input stream 512 and initially processed at node 524 which contains identifier of input stream 513 with key value “Charles” with status 2 (merging). Because the status indicators of these two key values are both 2 (merging), a key comparison is performed. Key value “Charles” remains the loser when compared to key value “Baker” from input stream 512, and therefore remains in node 524 with status 2 (merging). The winner of this key comparison, the key value “Baker” from input stream 512 is processed next at node 522, where it is compared to key value “Able” from input stream 514 with status 2 (merging). In this key comparison the value from input stream 512 is the loser of the comparison of step 216 and replaces the contents of node 522. The previous contents of node 522, identifying input stream 514 with key value “Able” and status 2 (merging) are processed at node 521. Because the previous contents of node 521 include status of 0 (empty), those contents are instantly promoted to the winning node 520, and node 521 stores the identifier of input stream 514 with key value “Able” and status 2 (merging).

FIG. 5G begins by processing the key value “Baker” from input stream 511 with status 2 (merging) at node 523. Node 523 identified input stream 510 having key value “Able” and status 2 (merging) in the previous step (FIG. 5F), while the status of the value from input stream 511 is also 2 (merging). A key comparison is therefore performed, and is won by the value “Able” from input stream 510. The value from input stream 511 replaces the contents of node 523 with status 2 (merging), and the previous contents identifying input stream 510 are processed at node 521 which identifies input stream 514 having key value “Able” and status 2 (merging). Because the key values are the same, step 220 leaves unchanged the input stream identifier of node 521 but changes its status to 1 (duplicate). The key value from input stream 510 wins at node 521 and is then stored in winning node 520 with its status 2 (merging). Because its status is not 0 (empty), this winning key value “Able” is output to output stream 500. By assigning the status 1 (duplicate) at node 521, the algorithm of this invention has made preparation for avoiding a key comparison in a subsequent stage of the tree's processing.

FIG. 5H processes the next value from input stream 510 through the tree, since that input stream was the winner of the previous stage (FIG. 5G). The key value “Able” from input stream 510 is first processed at node 523 as described above for FIG. 5G, winning that comparison. At node 521 in this stage of the tree, one of the key advantages of the invention becomes apparent. In the previous stage (FIG. 5G), node 521 identified input stream 514 with status 1 (duplicate). Now processing at node 521, the status indicator 2 (merging) associated with the current key value “Able” from input stream 510 is greater than that node's preexisting status indicator 1 (duplicate). Comparing those two status indicators at step 208, the new status indicator 2 (merging) of input stream 510 is greater than the preexisting status 1 (duplicate), causing execution to branch to step 210, replacing the contents of node 521 with the identifier of input stream 510 and its status 2 (merging), and promoting that node's preexisting contents to winning node 520. This promotion is done soley on the basis of a comparison between the status indicators, without requiring a key comparison, reducing processing time and thereby increasing performance of the replacement selection algorithm as improved by this invention. The new contents of winning node 520 are then output to output stream 500 with key value “Able”. In this stage of the tree's processing, one key comparison was saved by testing status indicators at node 521 at step 208 and promoting the winner of that status comparison at step 210.

FIG. 5I shows the tree processing the next value from input stream 514, which provided the winning value in the previous stage of the tree (FIG. 5H). Input stream 514's next key value is “Baker”, which is processed with status 2 (merging) at node 525. Because node 525 previously contained the same key value “Baker” from input stream 515 with status 2 (merging), the duplicate processing steps 216, 218, 220 leave the input stream identifier of node 525 intact but change its status indicator to 1 (duplicate), and promote the value from input stream 514 to the next node 522. Similarly, because node 522 contains the same key value “Baker” from input stream 512, step 220 changes its status to 1 (duplicate), and the value from input stream 514 is promoted for processing at node 521. Since node 521 has status 2 (merging) a key comparison is performed resulting in promotion of the value from input stream 510 “Able” to the winning node 520, leaving the identifier of input stream 514 with key value “Baker” and status 2 (merging) in node 521. The winning key value from winning node 520 is then copied to the output stream 500.

FIG. 5J processes the key value “Baker” from input stream 510, which provided the previous winning key value. The key value “Baker” with status 2 (merging) is processed first at node 523, which currently holds the same key value from input stream 511 with status 2 (merging). Because the status values are both 2 (merging), the tests of steps 208, 214, 216 and 218 of the algorithm cause the status indicator of node 523 to change to 1 (duplicate) without changing that node's indicator of input stream 511, and the key value from input stream 510 is promoted for processing at node 521. Similarly, because node 521 already has status 2 (merging) with key value “Baker”, only the status of node 521 is changed to 1 (duplicate), and the key value and status from input stream 510 are promoted to the winning node 520 and output to output stream 500. In FIG. 5K another key value, again “Baker” is taken from input stream 510 which provided the winner of the previous stage (FIG. 5J), and that key value is processed at node 523. However, here the advantage of the improved replacement selection algorithm of this invention becomes apparent, because the test of step 208 identifies the duplicate key values being processed. Step 212 instantly promotes the duplicate contents previously stored in node 523 to winning node 520 because that node previously had status 1 (duplicate). The winning key value “Baker” is therefore written to the output stream 500 without any key comparisons being performed. FIG. 5L takes the next value from input stream 511, with key value “Baker” and status 2 (merging), and processes those values at node 523, which contains key value 0 “Baker” with status 2 (merging) from the previous stage of the tree (FIG. 5K). Because both have status 2 (merging), steps 208 and 214 of the algorithm cause a key comparison to be performed by step 216, which in this case branches to identification of the identical key values by step 218. Step 220 therefore changes the status of node 523 to 1 (duplicate) leaving its identifier of input stream 510 unchanged, and promotes the value and status from input stream 511 to node 521 which identifies key value “Baker” from input stream 514 with status 1 (duplicate). Because the status 1 (duplicate) of node 521 is less than that of the new value presented from input stream 511, the input stream identifier, key value and status indicator from input stream 511 replaced the contents of 521, and that node's contents are promoted directly into winning node 520 and output to output stream 500. Thus, in this stage of the tree the next key value and output stream identifier were output to output stream 500 with only a single key comparison (at node 523), omitting a second key comparison at node 521.

It will be observed from the contents of output stream 500 at the stage of the tree shown in FIG. 5L that the improved algorithm of this invention avoids exhausting a single input stream's duplicate key values, instead alternating between the streams containing those values. Thus, the three key values “Able”—two from input stream 510 and one from input stream 514—were written alternately to the output stream rather than writing both values from input stream 510, followed by the value from input stream 514. Similarly, the first three “Baker” key values written to the output stream were taken from input streams 510, 511 and 514, rather than being taken all from any one input stream. This round robin consumption of duplicate key values from the input streams 510-515 reduces the possibility of incorrect behavior such as a deadlock. Such a deadlock can occur in prior art systems where: (1) there are buffering or data flow limits on the amount of resources needed to move data from the input streams to the output streams; (2) the sort and merge are parallelized among more than one sort and more than one merge; and (3) the output stream is partitioned among the merge operators via the sort key or another key functionally dependent on the sort key.

### Advantages Over The Prior Art

When duplicate sort-key values are present in the input streams, the duplicate handling of this invention reduces the number of sort-key comparisons required, compared to the unimproved replacement selection algorithm. This improves performance when the number of duplicate sort-key values is large, and/or when the sort keys are long or complicated to compare.

In a parallel implementation, the duplicate handling of this invention provides better load balancing by evenly consuming items from the input streams bearing duplicate values, rather than exhausting the duplicate values from one input stream at a time. And as a result of evening the consumption of duplicate values from input streams, this invention can prevent a type of deadlock that is specific to parallel ordered merges that have memory resource limitations affecting the input streams.

And if duplicate elimination is to be performed at the end of the merge, the tagging of duplicate values can also be leveraged to reduce the number of additional key comparisons needed for duplicate elimination.

### Alternative Embodiments

It will be appreciated that, although specific embodiments of the invention have been described herein for purposes of illustration, various modifications may be made without departing from the spirit and scope of the invention. In particular, while the preferred embodiment is implemented in a loser-oriented selection tree, the invention is equally applicable and advantageous to a winner-oriented selection tree, and in fact to any other form of selection tree useful with the replacement selection algorithm. And while the operation of the algorithm has been described in the context of a final merge of sorted inputs, the replacement selection algorithm and the improvement of this invention are equally useful in the preparation of initial runs of sorted output from unsorted input. Finally, while the data structures used to store the key values, status indicators and other data used by the invention's algorithm have been described as arrays having one or more values per element, it will be understood that other data structures such as tables, linked lists, or registers could be used to store the essential data needed for the operation of the algorithm. Accordingly, the scope of protection of this invention is limited only by the following claims and their equivalents.

I claim:

1. A replacement selection method for organizing data items from two or more input streams comprising the steps of:
identifying a data item being processed from one of the input streams as being a duplicate of a previously processed data item;
retaining an indication that the data item being processed is a duplicate data item; and
organizing the data items responsive at least in part to the indication that the data item being processed is a duplicate data item.

2. The method of claim 1, wherein the indication that the data item being processed is a duplicate data item is one value of an indicator having values corresponding to “empty”, “duplicate”, “merging” and “done”.

3. The method of claim 2, wherein:
the indicator is an integer variable;
the indicator value corresponding to “empty” is the value zero;
the indicator value corresponding to “duplicate” is the value one;
the indicator value corresponding to “merging” is the value two; and
the indicator value corresponding to “done” is the value three.

4. The method of claim 3, wherein the step of organizing is reponsive to comparisons between the values of the integer variable indicator values associated with data items being compared.

5. The method of claim 1, wherein the method is a replacement selection method using a loser-oriented selection tree.

6. A computer-readable data structure representing a selection tree for use in a computer-implemented replacement selection method of organizing data items from two or more input streams, comprising
for each node of the selection tree:
an identifier of one of the input streams,
a reference to a data item being processed from that one of the input streams; and
an indication whether the data item being processed is a duplicate.

7. The data structure of claim 6, wherein the indication that the data item being processed is a duplicate is one value of an indicator having values corresponding to “empty”, “duplicate”, “merging” and “done”.

8. The data structure of claim 7, wherein:
the indicator is an integer variable;
the indicator value corresponding to “empty” is the value zero,
the indicator value corresponding to “duplicate” is the value one;
the indicator value corresponding to “merging” is the value two; and
the indicator value corresponding to “done” is the value three.

9. An article for use in a computer implemented replacement selection method for organizing data items from two or more input streams comprising:
a computer-readable signal-bearing medium;
means in the medium for identifying a data item being processed from one of the input streams as being a duplicate of a previously processed data item;
means in the medium for retaining an indication that the data item being processed is a duplicate data item; and
means in the medium for organizing the data items responsive at least in part to the indication that the data item being processed is a duplicate data item.

10. The article of claim 9, wherein the indication that the data item being processed is a duplicate data item is a value of an indicator having values corresponding to “empty”, “duplicate”, “merging” and “done”.

11. The article of claim 10, wherein the indicator is an integer variable;
the indicator value corresponding to “empty” is the value zero;
the indicator value corresponding to “duplicate” is the value one;
the indicator value corresponding to “merging” is the value two; and
the indicator value corresponding to “done” is the value three.

12. The article of claim 11, wherein the means for organizing is reponsive to comparisons between the values of the integer variable indicator values associated with data items being compared.

13. The article of claim 9, wherein the method is a replacement selection method using a loser-oriented selection tree.

14. The article of claim 9, wherein the medium is selected from the group consisting of a recordable data storage medium; and a modulated carrier signal.
